(19) United States
(12) Patent Application Publication
(10) Pub. No.: US 2020/0070773 A1
(43) Pub. Date: Mar. 5, 2020

(54) AUTHENTICATION ARRANGEMENT AND SYSTEM FOR A MOTOR VEHICLE

(71) Applicant: HUF HÜLSBECK & FÜRST GMBH & CO. KG, Velbert (DE)

(72) Inventors: Sven Gennermann, Velbert (DE); Robin Neitzel, Bochum (DE); Levent Gozuyasli, Duisburg (DE); Daniel Bambeck, Essen (DE)

(73) Assignee: Huf Huelsbeck & Fuerst GmbH & Co. KG, Velbert (DE)

(21) Appl. No.: 16/610,006

(22) PCT Filed: Feb. 21, 2018
(86) PCT No.: PCT/EP2018/054198

§ 371 Date: Oct. 31, 2019

(30) Foreign Application Priority Data
May 2, 2017 (DE) 10 2017 109 345.1
Oct. 10, 2017 (DE) 10 2017 123 548.5

(51) Int. Cl. B60R 25/04; B60R 25/24; B60R 25/22; F02D 35/00; H04W 12/06

(52) U.S. Cl. CPC B60R 25/04; B60R 25/24; H04W 12/06; F02D 35/00; B60R 25/22

(57) ABSTRACT

An authentication arrangement for a motor vehicle includes an immobilize transponder, a first reception device, a control device and, optionally, a transmission and reception device. The immobilize transponder is switchable at least between an active operating state, which causes deactivation of the engine immobilizer, and an inactive operating state. The control device is designed to respond to a prescribed control signal captured by the first reception device by outputting a switching signal for switching the operating state of the immobilize transponder to the active operating state. An authentication system and a use of the authentication system are also disclosed.

The invention relates to an authentication arrangement for a motor vehicle. The invention is further directed to an authentication system and to a use of an authentication arrangement.

The authentication arrangement of the present application relates to a device which allows the operator to access a function of a motor vehicle. The general term of the authentication arrangement also includes concepts such as vehicle keys, ID transmitters or the like. But arrangements may also be provided which are not centrally designed and which are partially or fully connected to the vehicle. It is essential that a locked function of a motor vehicle can be triggered or released for triggering using the authentication arrangement. The function may include, for example, starting an engine or granting access to the motor vehicle.

In particular, the invention is directed to authentication arrangements that are useful in connection with shared motor vehicles. In shared motor vehicles, the situation is that the operation of the motor vehicle is assigned to different people, wherein the assignment is usually granted only temporarily.

An example of how a shared use of motor vehicles can be implemented is apparent from DE 10 2011 107 998 A1. This document describes a device for a vehicle which, in dependence on a previous authentication, deactivates the detection of a key on the vehicle side. This adaptation of the vehicle-side detection is implemented by adapting the vehicle-mounted control unit.

Another system is disclosed in DE 10 2011 116 209 A1. This document describes a device for activating and deactivating a locking and/or control system for a vehicle. Among other things, it is provided that a mobile ID transmitter is temporarily deactivated by means of the motor vehicle-side control unit.

The solutions known from the prior art have the disadvantage that they are an integral part of the infrastructure of the motor vehicle. This means that a subsequent adaptation of existing vehicles is not possible or is possible only with great effort.

The invention is therefore based on the object to provide an authentication arrangement for a motor vehicle, which is suitable for authentication of operators in shared vehicles and which can be used as an extension of existing vehicles with less effort or cost deployment when compared to the solutions known from the prior art.

The object is achieved with an authentication arrangement for a motor vehicle having the features of claim 1, with an authentication system for a motor vehicle having the features of claim 13 and with a use having the features of claim 17.

An authentication arrangement for a motor vehicle is provided. The authentication arrangement for the motor vehicle comprises:

an immobilize transponder means for deactivating an engine immobilizer of the motor vehicle,

a first reception device, which is set up to receive radio communication,

a control means coupled to the first reception device and to the immobilize transponder means for evaluating radio communication received by the first reception device and for issuing control instructions to the immobilize transponder means.

The immobilize transponder means is switchable at least between an active operating state and an inactive operating state. The active operating state is characterized at least in that the immobilize transponder means in the active operating state causes the deactivation of the engine immobilizer.

The engine immobilizer itself may be, for example, a retrofit system which interrupts the ignition, the fuel supply and/or the starter via one or more relays. Engine immobilizers which operate via a release message to the engine control unit may also be provided.

The immobilize transponder means is arranged to transmit information to an entity or a component of the engine immobilizer, wherein said entity or component detects the received information as a prerequisite to cause the deactivation of the engine immobilizer.

According to the invention, it is provided that the control means is designed to output a switching signal in response to a predetermined control signal detected by the first reception device. The switching signal is intended to switch the operating state of the immobilize transponder means into the active operating state.

The invention provides a possibility to give an operator access to an operation of the motor vehicle. By providing a switchable immobilize transponder means which assumes its active operating state in response to the switching signal, a temporary access granting tool is provided. This can be used to assign a temporary authorization to operate the motor vehicle or at least individual functions of the motor vehicle. The interface used is the first reception device, which is preferably designed to receive radio signals. As soon as the first reception device receives a corresponding control signal, the control means causes the operating state of the immobilize transponder means to be switched to the “active” state, thereby releasing the operation of the motor vehicle or at least functions of the motor vehicle. A check whether the received control signal is actually a predetermined or optionally the only predetermined control signal, which is to authorize the activation of the immobilize transponder means, can be done for example by the control means. Whether any security mechanisms, such as the use of symmetrical or asymmetrical cryptographic methods, are provided for this purpose and which they are, can be considered during the implementation depending on the respective security requirements.

Preferably, the authentication arrangement is portable, such that it can be carried by an operator.

In one embodiment of the invention, it is provided that the immobilize transponder means has an active transponder, which is switchably coupled to a power supply. It is provided that the switching state of the power supply is switched by means of the control means to thereby switch the immobilize transponder means at least between its active operating state and its inactive operating state.

In other words, when using an active transponder by engaging in its power supply in a simple manner, the corresponding ability of the immobilize transponder means for communication with the engine immobilizer of the motor vehicle is allowed or prevented.

According to a further development of the authentication arrangement, it can be provided that the immobilize transponder means has a crypto-chip transponder. In a special case, it can be provided that the immobilize transponder means is designed as a crypto-chip transponder. The so-called crypto-chip transponders are low-cost items that can be additionally trained on a specific type of motor vehicle.

In particular, a crypto-chip transponder can be provided, which is based on LF technology and has an integrated circuit. Such systems are sold for example by the company NXP under the names HITAG, HITAG 2, HITAG AES and HITAG μ. These or comparable commercial crypto-chip transponders may be used for use with the authentication arrangement. A disadvantage of such a crypto-chip in hardware configuration is that the switchable integration into the authentication arrangement is complicated. For example, a switching of the crypto-chip can take place by being positioned in a Faraday cage which partially or completely surrounds the crypto-chip.

Another possibility for providing the crypto-chip transponder may include, according to a development, that the crypto-chip transponder has a virtualized crypto-chip. This virtualized crypto-chip is coupled according to this development with transmitting and receiving means with which the crypto-chip acts as immobilize transponder means.

The emulation of crypto-chips is known. The use of an emulated crypto-chip is associated with the advantage that the functionality of the crypto-chip can be influenced by software measures, such that, for example, the switching of the operating state of the immobilize transponder means can be brought about by a program instruction. As a virtualized crypto-chip, for example, a microchip or a number of mutually coupled microchips can be provided, on which the crypto-chip is emulated as a result of appropriate programming which is implementable for a person skilled in the art.

According to one embodiment, it may be provided that the crypto-chip transponder is configured to be configurable, wherein the authentication arrangement for deactivating the engine immobilizer of a selected vehicle type and/or vehicle model can be adapted by means of configuration of the crypto-chip transponder.

For example, the crypto-chip transponder can be configured to be configurable by storing a number of adjustment sets on a storage means coupled to the crypto-chip transponder. For example, it may be provided that an adjustment set is selected and activated via an external interface, which henceforth determines the functionality of the crypto-chip transponder. This is where the advantage of the virtualized crypto-chip transponder comes into play, since it provides the option of adapting the authentication arrangement via the provisioning and selection of adjustment sets. The adaptation can be made, for example, to a specific vehicle type or to a specific data model.

According to a further advantageous embodiment, it may alternatively or additionally be provided that the first reception device is designed configurable, wherein the authentication arrangement for receiving predetermined signals is customizable by means of configuration of the first reception device. Thus, the existing hardware equipment of the first receiving device can be adapted by software, for example on the basis of on presets stored the receiving device, to a transmission device which is respectively selected for use.

Basically, the described concept of adjustability of the authentication arrangement has the advantage that a universal authentication arrangement blank can be provided, which can be adapted by software adaptation to a concrete usage environment. The ability to provide a universal authentication arrangement blank can minimize manufacturing costs since the adaptability is implemented as much as possible on the software side, and thus can be downstream of the manufacturing of the authentication arrangement.

According to another embodiment, provision is made for verification data to be stored on a storage means of the control means or a storage means connected to the control means, wherein the data can be used to verify a received radio signal. As part of the verification, it is checked whether a radio signal received by the reception device is to be regarded as the predetermined control signal. For verification, a comparison of the received data with target data stored on the storage means takes place; alternatively, or additionally, it may also be provided that data are stored on the memory means, wherein the data are derived from the predetermined control signal, and that the authenticity of the control signal received as a radio signal is verified via a corresponding comparison function, for example by forming a hash value.

According to a further embodiment it can be provided that the control means has a timer. Alternatively,a or additionally, it can be provided that the control means is coupled to a timer. With the timer, the control means can switch the immobilize transponder means into its inactive operating state after a predetermined maximum active time of said immobilize transponder means. The maximum time can be transmitted to the control means, for example, with the active switching, such that the period of access grant can be checked in the authentication arrangement itself. This has the advantage that a connection between the authentication arrangement and the external device is no longer necessary.

According to one embodiment, it can be provided that the authentication arrangement has a transmission and reception device which is set up for wireless communication of the authentication arrangement with a vehicle-side control device for wireless data exchange between the authentication arrangement and the control device. It is preferably provided that the transmission and reception device is designed as an LF and/or HF interface. In a special embodiment, the authentication arrangement is thus provided with an LF and HF interface, as is often used in Keyless Go or Passive Entry Passive Start ID transmitters. The advantage is that these interfaces are known, readily available and inexpensive in the field of motor vehicle authentication arrangements.

In an advantageous development of the authentication arrangement, it can be provided that the transmission and reception device is arranged in a configurable manner. The configurability is set up such that the authentication arrangement can be adapted by means of configuration of the transmission and reception device for wireless data exchange with a vehicle-side control device of a selected vehicle type and/or a selected vehicle model. For the first delivery of the authentication arrangement as a blank, a selection of pre-stored adjustment parameters, also referred to as presets, is already stored on a storage means of the transmission and reception device or on a storage means coupled to the transmission and reception device, and the transmission and reception device is set up in a controllable manner in the authentication arrangement such that a configuration of the transmission and reception device allows for the use of the transmission and reception device for a selected vehicle model or a selected vehicle type. Particularly preferably, a desired preset can be selected via an access interface of the authentication arrangement both from a selection of stored presets, and, if required, an individual single adjustment of adjustable parameters can take place. By providing a single adjustment, the flexibility of the provided configurability is further increased since adaptation to vehicle models or types not yet published at the time of manufacture can be made.

The provision of an authentication arrangement that is as comprehensively configurable as possible results in the already mentioned advantage that the same configuration arrangement can be used for a large number of vehicles and thus can be produced identically in large numbers.

A configurability could be supported for example by coupling a computer via a USB interface or a Bluetooth interface of the authentication arrangement. For example, it can be provided that an initial configuration of an authentication arrangement, which may be a one-time configuration and therefore also the last configuration, is made when the vehicle is put into operation by its manufacturer or its seller.

The configurability may include, for example, that a selection and/or an adjustment is made by:
Used protocol,
parameters such as timing behavior, transmission frequency or the like,
used cryptographic method.

The scope of the configurability is fundamentally limited only by the hardware limits of the authentication arrangement and by the limits of the individual components of the authentication arrangement set by manufacturers or regulatory authorities.

Furthermore, it can be provided that the first reception device is designed as an LF interface and/or as an HF interface. Because the first reception device is embodied as an LF interface and/or as an HF interface, the reception of radio communication, in particular of the predefined control signal, can be performed by the authentication arrangement via readily available interfaces. In a specific embodiment, it can also be provided that the first reception device is part of the aforementioned transmission and reception device, such that the number of components used is minimized.

According to a further embodiment, the first reception device can be designed as a Bluetooth low-energy interface (BLE interface). Advantage of the use of a Bluetooth low-energy interface in the authentication arrangement is both the good availability and the very low energy consumption.

According to a specific development, it can be provided that the authentication arrangement is designed as a portable ID transmitter. In the embodiment of the authentication arrangement as a portable ID transmitter, the advantage results, in particular for the operator, in that the authentication arrangement corresponds in its user behavior to what he knows from the motor vehicle operation for some time.

In particular, provision may be made for the operator to be provided with a portable ID transmitter which has LF/HF functionality in order to be part of a Keyless Go or Passive Entry Passive Start system of the motor vehicle to be used. Characterized in that the ID transmitter has the immobilize transponder means, which is switched in response to the predetermined control signal in its active operating state, a known operation of the motor vehicle is enabled for the operator. At the same time a temporary grant of access to the operation of the motor vehicle is possible. Among other things, this property can be advantageously utilized by always placing the ID transmitter in the vicinity of or inside the motor vehicle and exercising control over the operability of the motor vehicle by triggering the switching signal. Another possibility is that there is a plurality of identical ID transmitters, all of which are set up for operation of the same motor vehicle. The plurality of identical ID transmitters is possible because the triggering of the switching signal can be set up such that at any given time at most only one of the plurality of ID transmitters is activated.

Alternatively, or additionally, it can be provided that the authentication arrangement is designed as a mechanical motor vehicle key having at least one key bit.

The invention further relates to an authentication system for a motor vehicle.

The authentication system comprises an authentication arrangement, preferably one of the above-described authentication arrangements or their developments.

The authentication arrangement further comprises:

a base station having a transmission device for transmitting the predetermined control signal,

a radio device arranged at the base station and coupled to the transmission device, wherein the radio device is set up to receive an activation signal and to cause a transmission of the predetermined control signal for switching the immobilize transponder means into its active operating state by means of the transmission device of the base station after confirming a permission by checking the activation signal.

The authentication arrangement has, as explained above, at least the first reception device which is capable of receiving the predetermined control signal. The base station is preferably constructive, in particular in shape and dimension designed such that the authentication arrangement can be arranged within the base station, at the base station or positioned in the vicinity of the base station. In a special embodiment, it can also be provided that some or all elements of the authentication arrangement are connected to some or all elements of the base station in a detachable or non-detachable manner. However, it is preferred that the base station is designed in such a way that it can be inserted into or taken out of it independently of the provided authentication arrangement.

The radio device of the base station receives the activation signal. It is provided that within the base station, the activation signal is checked for authorization. Checking the activation signal for authorization can be carried out, for example, within a circuit which is part of the radio device. Alternatively, or additionally, it can also be provided that the test of the activation signal is performed by a specially set up test circuit. It is substantial that the successful examination of the authorization is a necessary condition for causing the transmission device of the base station to transmit the predetermined control signal.

The authentication system according to the invention therefore provides an infrastructure by means of which an authentication arrangement, preferably of the kind explained above, can be coupled in a controllable manner. The authentication system serves as an interface between a device emitting an activation signal and the authentication arrangement. This ensures that the access granting or operability granting of the motor vehicle can be assigned to the device emitting the activation signal.

According to one embodiment of the authentication system, it can be provided that the radio device is designed as a Bluetooth interface, as a Bluetooth low-energy interface (BLE interface) and/or as a WLAN interface. Thus, a device correspondingly equipped for BLE and/or WLAN communication can be provided for transmitting the activation signal in order then to affect the output of the control signal, which in turn causes the switching of the operating state of the immobilize transponder means into the active operating state after receipt by the first reception device of the authentication arrangement.

According to one embodiment of the authentication system, it can be provided that the transmission device is designed as a Bluetooth interface, a Bluetooth low-energy interface (BLE interface) and/or LF interface, wherein the embodiment of the transmission device to the first reception device of authentication arrangement is to be matched, which is to be used in combination with the authentication system.

By using the widely used interfaces for Bluetooth, BLE and/or WLAN communication, for example, a smartphone with a suitably adapted app can be used as the device provided for transmitting the activation signal.

The envisaged authentication system thus functions as part of an infrastructure that is advantageous in several respects. For example, a possible advantage in the provision of the authentication system is that by inserting an authentication arrangement or by connecting the authentication arrangement to the authentication system with an appropriately designed base station, the manual access to the authentication arrangement itself can also be prevented for the operator. As a result, an additional security gain can be ensured. Furthermore, the authentication system can be provided relative to the motor vehicle as a stationary unit, As a result, less spatial restrictions must be observed than with the authentication system. Accordingly, more powerful hardware can be used, that is, for example, a more powerful computing unit may be provided in the authentication system. As a result, for example, more complex authentication methods are easier to implement or use, such as asymmetrical authentication methods.

The authentication system may comprise holding means of the base station according to one embodiment, such that the authentication arrangement can be arranged at or within the base station. The holding means may be provided, for example, as holding handles, holding clips or as a room with lockable door.

Another advantageous embodiment of the authentication system provides that the base station has fastening means for permanently attaching the authentication arrangement to the motor vehicle.

Another idea is to use an authentication arrangement for temporarily providing access to a vehicle functionality of a motor vehicle which is coupled functionally to the authentication arrangement. The temporary provision of the access takes place by transmitting a predetermined control signal for activating an immobilize transponder means to the authentication arrangement. The activation of the immobilize transponder means causes the engine immobilizer of the motor vehicle to override. Alternatively, or additionally, it can be provided that the provision of access to the motor vehicle functionality takes place by transmitting the predetermined control signal by a decentralized infrastructure device. Upon receipt of the predetermined control signal and after its detection by the authentication arrangement, the immobilize transponder means is activated, whereby the engine immobilizer of the motor vehicle is disabled.

Further details, features and advantages of the subject of the invention will become apparent from the following description taken in conjunction with the drawings. In the drawings, an exemplary embodiment of the invention is shown.

It goes without saying that the features mentioned above and below can be used not only in the combination indicated but also in other combinations together or in isolation.

In the drawings:

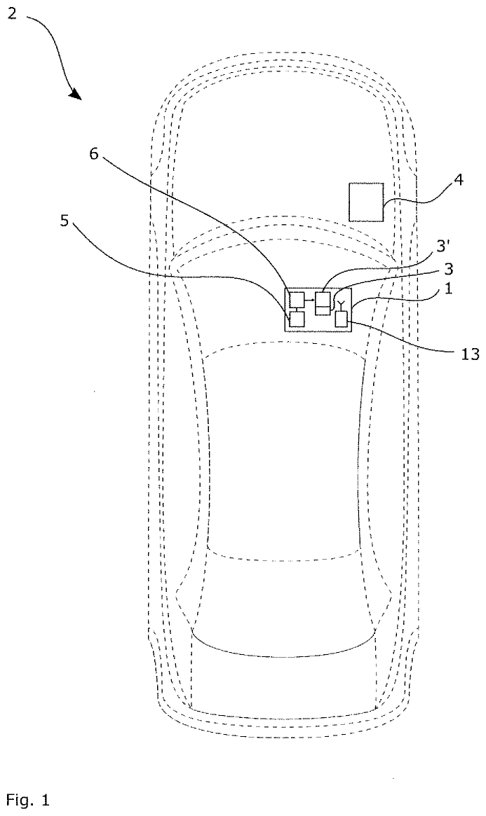

FIG. 1: Design of an authentication arrangement as a system arranged on the motor vehicle;

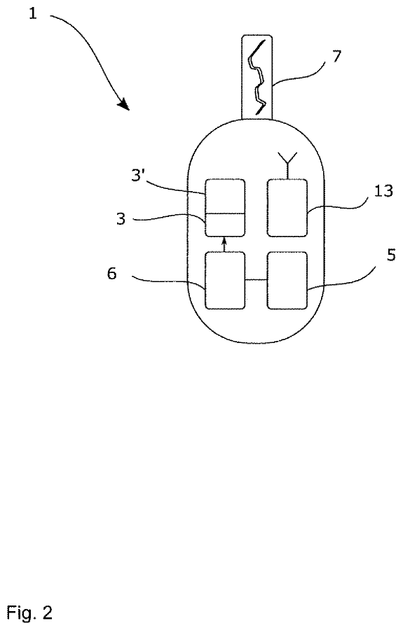

FIG. 2: Design of an authentication arrangement as a portable ID transmitter with mechanical motor vehicle key;

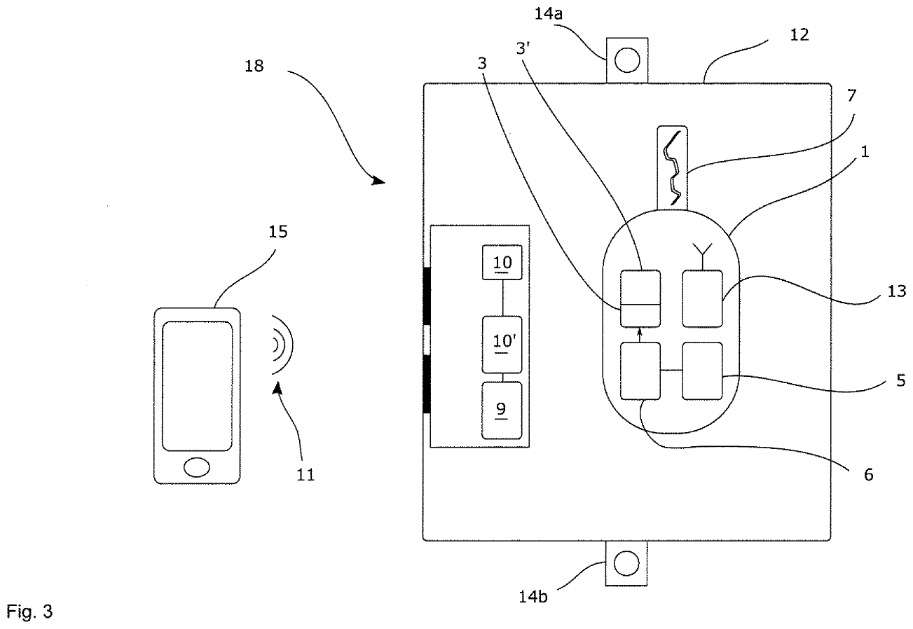

FIG. 3: Design of an authentication system.

In FIG. 1, a motor vehicle 2 is shown, which has an authentication arrangement 1. In the example of FIG. 1, the authentication arrangement 1 is a portable ID transmitter which is stored in the motor vehicle 2. The authentication arrangement 1 has an immobilize transponder means 3, which can be controlled by a control means 6. The control means 6 is coupled to a first reception device 5, which is designed, for example, as a BLE interface. Furthermore, the authentication arrangement 1 also has a transmission and reception device 13, which is designed as an LF/HF transmission device and is provided for communication of the ID transmitter with a motor vehicle-side control device 4 to provide a Keyless Go or Passive Entry Passive Start functionality. The immobilize transponder means 3 further comprises a virtualized crypto-chip, which is coupled to transmission and reception means 3′ and acts together with these as a crypto-chip transponder. The transmission and reception means 3′ are designed as passive transponders.

The first reception device 5 designed as a BLE interface is set up to perform a BLE communication with a smartphone. The smartphone is equipped with a suitably provided app capable of transmitting the predetermined control signal to the first reception device 5 by radio communication. After receipt by the reception device 5, the control signal is verified by means of control means 6. The verification can be done, for example, by using a symmetrically encrypted communication between the smartphone and BLE interface, which is carried out as part of a coupling or the establishment of the BLE connection (pairing) between the smartphone and the BLE interface 5. Once the control means 6 acknowledges receipt of the predetermined control signal, the control means 6 initiates the emulation of the virtualized crypto-chip, thereby placing the immobilize transponder means in the active operating state. By switching the immobilize transponder means into the active operating state, the deactivation of an engine immobilizer 4 of the motor vehicle is brought about.

FIG. 2 shows another embodiment of an authentication arrangement. The authentication arrangement 1 of FIG. 2 has in particular a key bit 7. The operator is thus given the opportunity to operate the motor vehicle with the key bit 7 by means of the mechanical operation of a lock, such as a door lock or an ignition lock. The operation is successful in this case only when the immobilize transponder means 3 is activated, which is done by a switching signal which is output in response to the receipt of a predetermined control signal whose authenticity is confirmed by the control means 6. The remaining constituent parts of the authentication arrangement 1 shown in FIG. 2 correspond to the elements shown in FIG. 1.

An embodiment of the authentication system 18 is shown in FIG. 3. The authentication system 18 has a base station 12, which is designed as a lockable box in the embodiment shown. The base station 12 is arranged undetachably within the motor vehicle 2 by means of an adhesive connection 14a, 14b. An authentication arrangement 1 is positioned within the lockable box, wherein said arrangement is designed as a portable ID transmitter having an additional mechanical key bit 7 according to the exemplary embodiment shown in FIG. 2. The ID transmitter has a transmission and reception device 13, which is designed as an LF and HF interface. With an LF antenna of the LF and HF interface, the ID transmitter receives corresponding polling signals of the motor vehicle. Then, the ID transmitter enters a bidirectional HF radio communication with the vehicle-mounted control unit. As part of this bidirectional exchange, the authentication of the ID transmitter is performed on the motor vehicle. After successful authentication, the operator is granted access to the motor vehicle and access to the operation of the motor vehicle. The ID transmitter 1 is set up such that the readiness of the ID transmitter 1 for radio communication with the vehicle-side control unit corresponds to the delivery state of the ID transmitter 1. The ID transmitter 1 has an immobilize transponder means 3, 3′ with which an engine immobilizer of the motor vehicle 2 can be deactivated. The switching on and off of the immobilize transponder means 3 occurs by means of the output of a switching signal by the control means 6 of the ID transmitter 1. The switching signal is output when the control means 6 detects the receipt of a predetermined control signal by the first reception device 5. The control signal, which is received by the first reception device 5, comes from the transmission device 9.

The prerequisite for a transmission of the control signal by the transmission device 9 is again the receipt of a corresponding activation signal 11 by a radio device 10. In the illustration shown, a smartphone 15 is used for the emission of the activation signal 11, on which a suitably prepared app is installed. With the app, a rental agent of the motor vehicle enables the transmission of the authorizing activation signal 11, which is transmitted via a Bluetooth connection to the radio device 10 of the base station 12. A computing unit 10′ of the base station 12 evaluates the activation signal 11 after receipt. If the computing unit 10′ recognizes the activation signal 11 received from the radio device 10 as authorizing, the transmission device 9 initiates the transmission of the predetermined control signal. The control signal is then received by the first reception device 5 of the ID transmitter 1 and used in the manner described above for deactivating the engine immobilizer.

1. Authentication arrangement for a motor vehicle, wherein the authentication arrangement comprises:
an immobilize transponder means for deactivating an engine immobilizer of the motor vehicle,
a first reception device, which is set up to receive radio communication,
a control means coupled with the first reception device and with the immobilize transponder means for evaluating radio communication, which is received by the first reception device, and for outputting control instructions to the immobilize transponder means, wherein
the immobilize transponder means is switchable at least between an active operating state, which causes the deactivation of the engine immobilizer, and an inactive operating state,
wherein the control means is arranged to output a switching signal for switching the operating state of the immobilize transponder means to the active operating state in response to a predetermined control signal detected by the first reception device.

2. Authentication arrangement according to claim 1, wherein the immobilize transponder means has an active transponder, which is switchably coupled to a power supply, and that the switching state of the power supply is switched by means of the control means for switching the immobilize transponder means at least between its inactive operating state and its active operating state.

3. Authentication arrangement according to claim 1, wherein the immobilize transponder means comprises a crypto-chip transponder.

4. Authentication arrangement according to claim 3, wherein the crypto-chip transponder has a virtualized crypto-chip which is coupled to a transmission and reception means and acts together with these as a crypto-chip transponder.

5. Authentication arrangement according to claim 4, wherein
the crypto-chip transponder is set up in a configurable manner, wherein by means of configuration of the crypto-chip transponder the authentication arrangement for deactivating the engine immobilizer of a selected vehicle type and/or a selected vehicle model is adaptable and/or
in that the first reception device is set up in a configurable manner, wherein by means of the configuration of the first reception device the authentication arrangement can be adapted to receive predetermined signals.

6. Authentication arrangement of claim 1, wherein verification data are deposited on a storage means of the control means or a storage means connected to the control means for verification by the control means, of whether a radio signal received by the reception device is to be regarded as the predetermined control signal.

7. Authentication arrangement according to any of the claim 1, wherein the control means comprises a timer or that the control means is coupled to a timer, and that the control means is arranged after a predetermined maximum active time of the immobilize transponder means to switch the immobilizer transponder means to its inactive operating state.

8. Authentication arrangement according to claim 1, wherein the authentication arrangement has a transmission and reception device, preferably designed as an LF and/or HF interface, which is set up for wireless communication of the authentication arrangement with a vehicle-side control unit for wireless data exchange between the authentication arrangement and the control unit.

9. Authentication arrangement according to claim 8, wherein the transmission and reception device is designed configurably wherein the authentication arrangement by means of configuration of the transmission and reception device is configurable for wireless data exchange with a vehicle-mounted control unit of a selected vehicle type and/or a selected vehicle model.

10. Authentication arrangement according to claim 1, wherein the first reception device comprises an LF interface and/or an HF interface.

11. Authentication arrangement according to claim 1, wherein the first reception device is designed as a Bluetooth low-energy interface (BLE interface).

12. Authentication arrangement according to claim 10, wherein
the authentication arrangement is designed as a portable ID transmitter and/or
the authentication arrangement is designed as a mechanical motor vehicle key with at least one key bit.

13. Authentication system for a motor vehicle, comprising
an authentication arrangement according to claim 12,
a base station having a transmission device for transmitting the predetermined control signal,
a radio device which is arranged at the base station and coupled to the transmission device, wherein the radio device is adapted to receive an activation signal and to cause a transmission of the predetermined control signal by means of the transmission device of the base station for switching the immobilize transponder means to its active operating state after a check of the activation signal has confirmed an authorization.

14. Authentication system according to claim 13, wherein the base station comprises retaining means for undetachably positioning the authentication arrangement at or within the base station.

15. Authentication system according to claim 13, wherein the base station has fastening means for the permanent attachment of the authentication arrangement on the motor vehicle.

16. Authentication system according to claim 13, wherein the radio device is designed as a Bluetooth interface, as a BLE interface and/or as a WLAN interface.

17. Use of an authentication arrangement according to claim 12 for temporarily providing access to a motor vehicle functionality of a motor vehicle which is coupled functionally to the authentication arrangement by
transmitting a predetermined control signal to the authentication arrangement for activating an immobilize transponder means, such that the engine immobilizer of the motor vehicle is disabled and/or
releasing the predetermined control signal for transmission to the authentication arrangement by a decentralized infrastructure for activating the immobilize transponder means, such that the engine immobilizer of the motor vehicle is disabled.
